(19) United States
(12) Patent Application Publication
(10) Pub. No.: US 2006/0259513 A1
(43) Pub. Date: Nov. 16, 2006

(54) System and method to submit image requests to DICOM server

(75) Inventor: Kevin M. Crucs, Akron, OH (US)

Correspondence Address: HAHN LOESER & PARKS, LLP, One GOJO Plaza, Suite 300, AKRON, OH, 44311-1076, US

(73) Assignee: APTERYX, INC.

(21) Appl. No.: 11/125,935

(22) Filed: May 10, 2005

(51) Int. Cl. G06F 17/00

(52) U.S. Cl. 707/104.1

(57) ABSTRACT

A system and method for submitting image requests to a DICOM server are disclosed. The system comprises at least one data manager operationally interfacing between a plurality of computer-based platforms (e.g., PC's, workstations, imaging machines) and the DICOM server. Each of the plurality of computer-based platforms is capable of generating and transmitting image requests. The DICOM server is capable of receiving and responding to image requests. The data manager administers a first security policy between the plurality of computer-based platforms and the DICOM server to determine which computer-based platforms are authorized to access images from or submit images to the DICOM server.

### TECHNICAL FIELD

Certain embodiments of the present invention relate to accessing a DICOM server to retrieve or store digital medical images. More particularly, certain embodiments of the present invention relate to a system and method to reduce the security burden of a DICOM server.

### BACKGROUND OF THE INVENTION

Digital Imaging and Communications in Medicine (DICOM) is a well-known standard for transferring images and associated information between devices manufactured by various vendors. Typically, a DICOM server is used to store, organize, and manage medical images. Various external systems may desire to communicate with a DICOM server to store images to the DICOM server and/or to retrieve images from the DICOM server by submitting image requests to the DICOM server.

However, in order to protect patient sensitive information and to comply with certain HIPPA (Health Insurance Portability and Accountability Act) requirements, security measures are used by the DICOM server to prevent unauthorized access to the DICOM server. The DICOM server typically implements a security policy in accordance with a standard security policy format as defined by the DICOM standard to authorize access. The security policy format stores an application entity title (AE_title), and IP address, and a port number associated with each authorized external system as part of the security policy on the DICOM server.

Unfortunately, the DICOM standard security policy format becomes inefficient and difficult to maintain as the number of authorized external systems becomes larger. In other words, the current DICOM standard is not sufficient to handle security for a relatively large number of requesting entities.

Further limitations and disadvantages of conventional, traditional, and proposed approaches will become apparent to one of skill in the art, through comparison of such systems and methods with the present invention as set forth in the remainder of the present application with reference to the drawings.

### BRIEF SUMMARY OF THE INVENTION

Certain embodiments of the present invention provide a system to submit image requests to a DICOM server. An image request may comprise a request to store an image or a request to retrieve an image. The system comprises a data manager operationally interfacing between a plurality of computer-based platforms and a DICOM server. The data manager administers a first security policy such that, when any of the computer-based platforms send an image request, the data manager determines if the requesting computer-based platform is authorized, as defined by the first security policy, to access images from or submit images to the DICOM server. The data manager sends authorized image requests to the DICOM server. The DICOM server administers a second security policy to determine if the data manager is authorized to access images from or submit images to the DICOM server. As a result, the data manager acts as a security gateway for the DICOM server. That is, the second security policy of the DICOM server does not have to deal with each individual requesting computer-based platform of the plurality of computer-based platforms since the first security policy of the data manager deals with each individual requesting computer-based platform. The system may further include additional data managers, in accordance with various embodiments of the present invention, operationally interfacing between the DICOM server and other pluralities of computer-based platforms. As a result, the second security policy of the DICOM server only has to deal with authorizing the data managers, not the pluralities of computer-based platforms. Each data manager administers its own security policy. In accordance with various embodiments of the present invention, any data manager may operationally interface to a corresponding plurality of computer-based platforms via a network such as, for example, a local area network (LAN) or a wide area network (WAN). Similarly, any data manager may operationally interface to the DICOM server via a network such as, for example, a WAN, a global information network (e.g., the Internet), or a LAN.

Certain embodiments of the present invention comprise a method to submit image requests to a DICOM server. The method comprises receiving an image request at a data manager from a requesting computer-based platform. As a further step in the method, the data manager administers a first security policy to determine if the requesting computer-based platform is authorized to access images from or submit images to the DICOM server. If the data manager determines that the requesting computer-based platform is authorized, then as another step in the method, the data manager sends the image request to the DICOM server. As still a further step in the method, the DICOM server administers a second security policy to determine if the data manager is authorized to access images from or submit images to the DICOM server. In accordance with various embodiments of the present invention, the data manager may receive many image requests from a plurality of requesting computer-based platforms. The first security policy of the data manager handles authorization of the plurality of requesting computer-based platforms. As a result, the DICOM server is relieved of having to deal with authorizing the plurality of requesting computer-based platforms. In accordance with various embodiments of the present invention, the second security policy of the DICOM server may be used to authorize more than one data manager where each data manager uses its own security policy to authorize a unique plurality of requesting computer-based platforms.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a schematic block diagram of an exemplary first embodiment of a system to submit image requests to a DICOM server, in accordance with various aspects of the present invention.

FIG. 2 is a flowchart of an exemplary first embodiment of a method to submit image requests to a DICOM server using at least a portion of the system of FIG. 1, in accordance with various aspects of the present invention.

FIG. 3 is a flowchart of an exemplary second embodiment of a method to submit image requests to a DICOM server using at least a portion of the system of FIG. 1, in accordance with various aspects of the present invention.

FIG. 4 illustrates two exemplary embodiments of security policies implemented in the system of FIG. 1 and used by the methods of FIG. 2 and FIG. 3, in accordance with various aspects of the present invention.

FIG. 5 is a schematic block diagram of an exemplary second embodiment of a system to submit image requests to a DICOM server, in accordance with various aspects of the present invention.

FIG. 6 is a schematic block diagram of an exemplary third embodiment of a system to submit image requests to a DICOM server, in accordance with various aspects of the present invention.

### DETAILED DESCRIPTION OF THE INVENTION

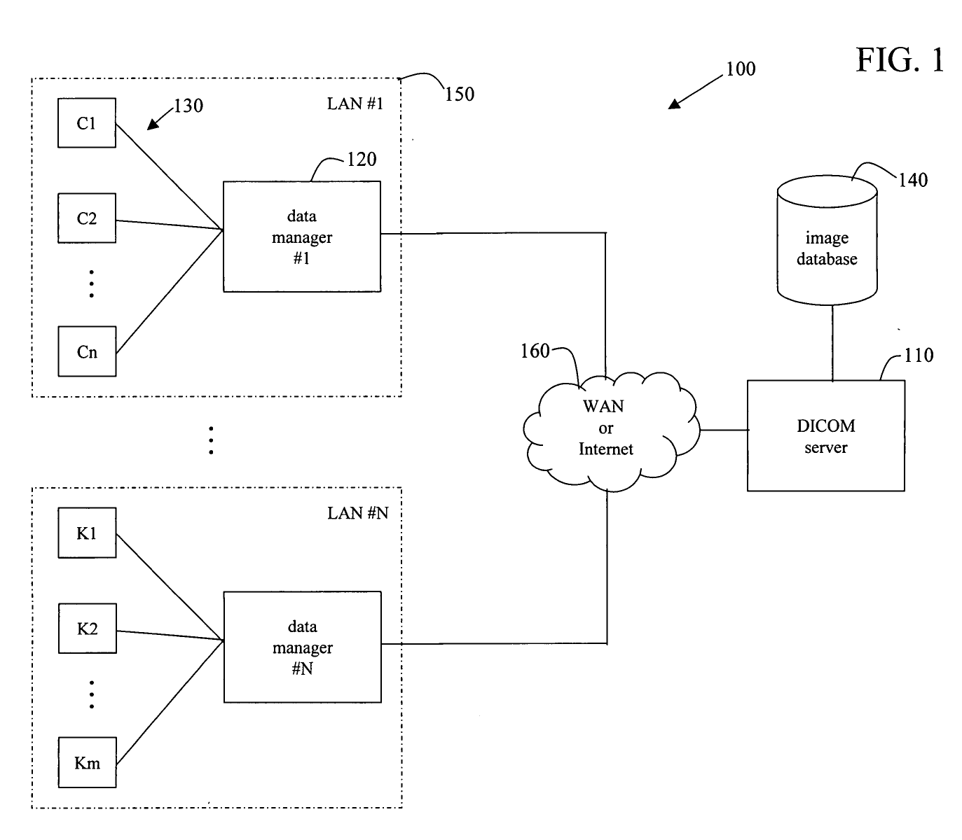

FIG. 1 is a schematic block diagram of an exemplary first embodiment of a system 100 to submit image requests to a DICOM server 110, in accordance with various aspects of the present invention. The general idea is to relieve the burden of the DICOM server 110 from having to authorize a large plurality of requesting computer-based platforms. In accordance with various embodiments of the present invention, an image request comprises a request to save a digital image to a DICOM server, or to retrieve a digital image from a DICOM server. The system comprises a first data manager 120 (data manager #1) operationally interfacing between a first plurality of computers 130 (C1 to Cn) and the DICOM server 110. The DICOM server 110 interfaces to a digital image database 140 in order to store digital medical images to and access digital medical images from the digital image data base 140. Alternatively, digital images may be stored directly on the DICOM server.

Each of the first plurality of computers 130 may include any processor-based platform such as, for example, a personal computer (PC), a work-station, or an imaging machine. The first data manager 120 operationally interfaces (wired or wirelessly) to the first plurality of computers 130 via a local area network (LAN) 150. The first data manager 120 operationally interfaces to the DICOM server 110 (wired or wirelessly) via a wide area network (WAN) or a global informational network 160 such as, for example, the Internet.

In accordance with various embodiments of the present invention, the system 100 may include additional data managers (e.g., data managers 2 to N) each operationally interfacing to a unique plurality of computers (e.g., K1 to Km). Each additional data manager operationally interfaces to the DICOM server 110 via the WAN or global informational network 160. Each data manager administers a security policy for authorizing the plurality of computers associated with each data manager. The DICOM server 110 administers a security policy only for authorizing the various data managers. As a result, the DICOM server 110 is not burdened with having to administer a security policy for all of the plurality of computers that may try to access images from or store images to the DICOM server 110.

In accordance with various embodiments of the present invention, the data managers follow DICOM protocols to communicate with the DICOM server. However, DICOM protocols may or may not be followed for communication between the plurality of computer-based platforms and the data managers.

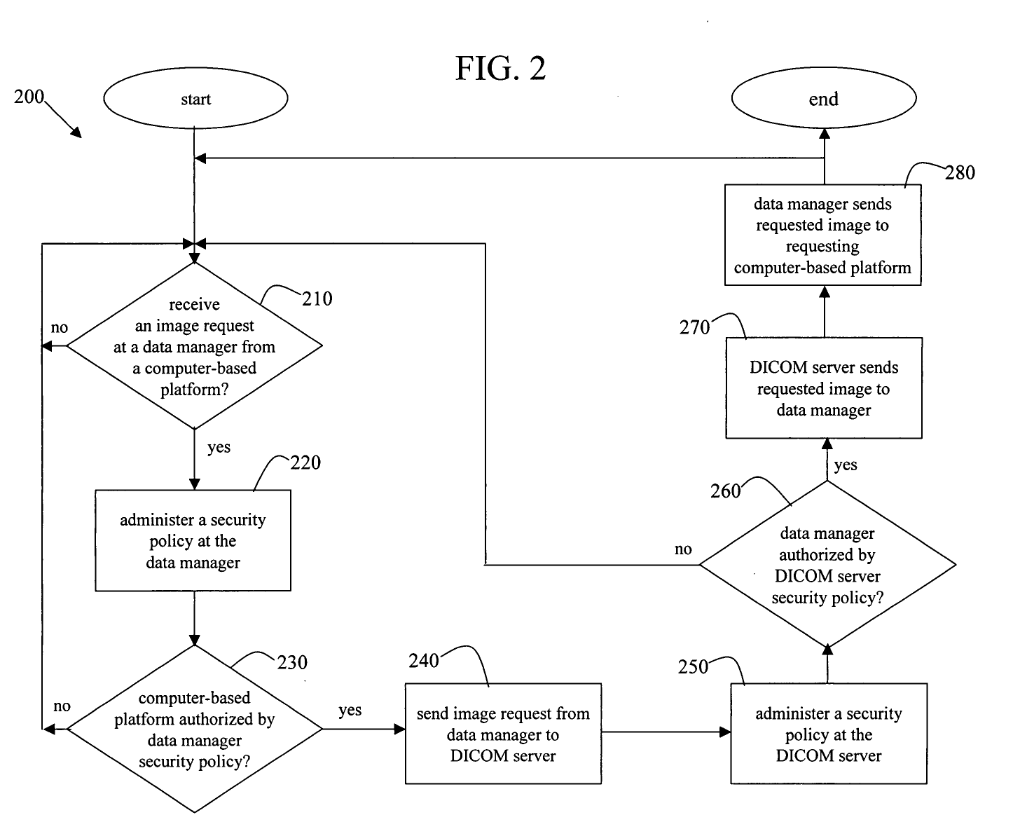

FIG. 2 is a flowchart of an exemplary embodiment of a method 200 to submit image requests to a DICOM server 110 using at least a portion of the system 100 of FIG. 1, in accordance with various aspects of the present invention. In step 210, an image request is received at a data manager from a computer-based platform. In step 220, the data manager administers a security policy such that a decision is made in step 230 as to whether or not the requesting computer-based platform is authorized to request images from the DICOM server. If the data manager does authorize the requesting computer-based platform then, in step 240, the image request is sent from the data manager to the DICOM server. Once the image request is received by the DICOM server then, in step 250, the DICOM server administers a security policy such that a decision is made in step 260 as to whether or not the data manager is authorized to request images from the DICOM server. If the DICOM server does authorize the data manager then, in step 270, the DICOM server accesses the desired image associated with the image request and sends the requested image to the data manager. In step 280, the data manager sends the requested image to the requesting computer-based platform.

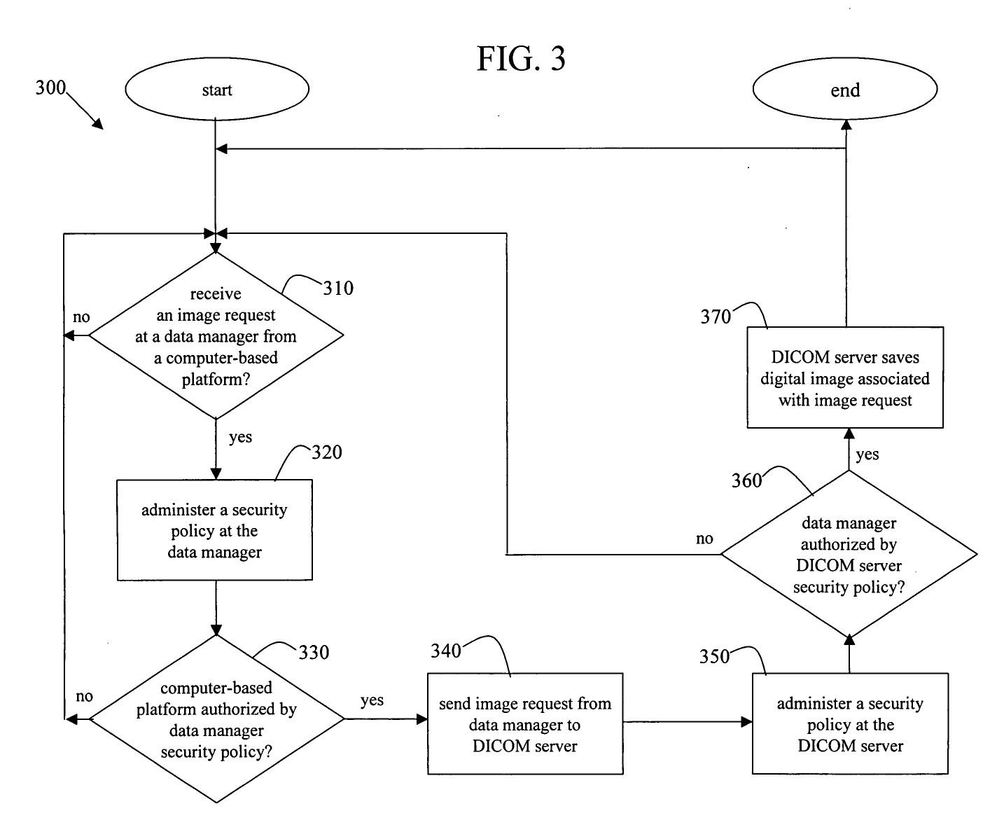

Similarly, FIG. 3 is a flowchart of an exemplary second embodiment of a method 300 to submit image requests to a DICOM server using at least a portion of the system of FIG. 1, in accordance with various aspects of the present invention. In step 310, an image request is received at a data manager from a computer-based platform. In step 320, the data manager administers a security policy such that a decision is made in step 330 as to whether or not the requesting computer-based platform is authorized to submit images to the DICOM server. If the data manager does authorize the requesting computer-based platform then, in step 340, the image request is sent from the data manager to the DICOM server. Once the image request is received by the DICOM server then, in step 350, the DICOM server administers a security policy such that a decision is made in step 360 as to whether or not the data manager is authorized to submit images to the DICOM server. If the DICOM server does authorize the data manager then, in step 370, the DICOM server saves a digital image associated with the image request. The digital image may be saved on the DICOM server 110 itself or to an image database 140, for example.

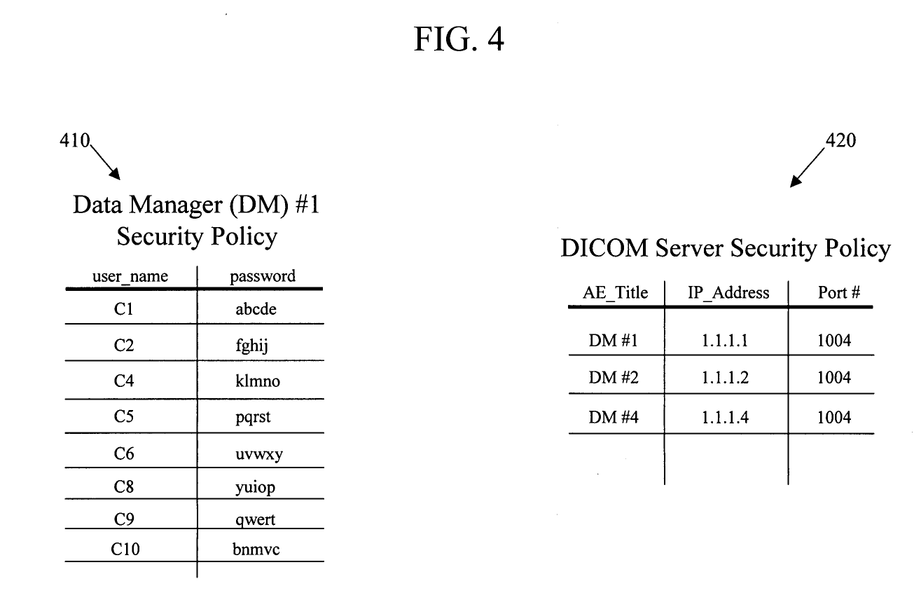

As an example, FIG. 4 illustrates two-exemplary embodiments of security policies 410 and 420 implemented in the system 100 of FIG. 1 and used by the methods 200 and 300 of FIG. 2 and FIG. 3, in accordance with various aspects of the present invention. In this example, there are ten computers 130 C1-C10 (i.e., n=10) that interface to the data manager #1 (DM #1) 120 via the LAN #1 150. Also, there are four data managers DM1-DM4 (i.e., N=4) that interface to the WAN 160.

The table 410 represents the security policy for the data manager #1 (DM #1) 120. The security policy 410 of the data manager #1 (DM #1) 120 is based on a user name and password scheme. Other security policy schemes are possible as well, in accordance with various embodiments of the present invention. Only those computers listed in the table 410 can be authorized by the DM #1 120 to submit image requests to the DICOM server 110. As can be seen in the table 410, of the ten computers C1-C10, computers C3 and C7 are not listed in the table 410. Therefore, computers C3 and C7 cannot be authorized to access images from or submit images to the DICOM server 110 via the data manager #1 120. Also, in order for any of the listed computers C1, C2, C4, C5, C6, C7, C8, C9, and C10 to be authorized by the data manager #1 120 when submitting an image request, that requesting computer must provide the correct user name and password, as defined in the table 410 in order for the data manager #1 120 to authorize that requesting computer.

The table 420 represents the security policy for the DICOM server 110. Only those data managers listed in the table 420 can be authorized by the DICOM server 110. As can be seen in the table 420, of the four data managers DM #1 to DM #4, data manager DM #3 is not listed in the table 420. Therefore, DM #3 cannot be authorized to access images from or submit images to the DICOM server 110. Also, in order for any of the listed data managers DM #1, DM #2, and DM #4 to be authorized by the DICOM server 110 when submitting an image request, that requesting data manager must provide the correct application entity title (AE_title), IP_address, and port number (port #), as defined in the table 420 in order for the DICOM server 110 to authorize that requesting data manager. However, other DICOM security policies are possible as well, in accordance with other embodiments of the present invention, as the DICOM standard changes.

As can be seen by the previous example, the DICOM server 110 only has to handle a security policy for the three data managers (DM #1, DM #2, DM #3) and not for the plurality of computers associated with the four data managers that may try to request an image from or submit an image to the DICOM server 110. Such a system 100 and methods 200 and 300 reduce the number of entitites (i.e., processor-based platforms) that need to be stored in the table 420 and also reduces the number of image requests to the DICOM server 110 that have to be checked for authorization by the DICOM server 110. In other words, most of the security policy burden is distributed over the four data managers (DM #1-DM #4), thus relieving the burden on the DICOM server 110.

The DICOM server security policy 420 is in accordance with the DICOM format. The data manager security policy 410 may use a user name/password implementation or may use any other type of security implementation that is deemed appropriate by the corresponding LAN administrator.

In accordance with an embodiment of the present invention, a security policy administered by a data manager can be implemented on the data manager. In accordance with a first alternative embodiment of the present invention, a security policy administered by a data manager may involve the data manager accessing a separate data base to access and administer the security policy. In accordance with a second alternative embodiment of the present invention, a security policy administered by a data manager may involve the data manager using an existing security LAN security policy (e.g., user_name/password security policy of the LAN).

In accordance with a third alternative embodiment of the present invention, a security policy administered by a data manager may involve the data manager relying on a security policy of a LAN which the data manager is an operational part of. For example, if a computer can access the LAN, which the data manager is an operational part of, then the data manager considers the computer authorized (e.g., relying on active directory permission).

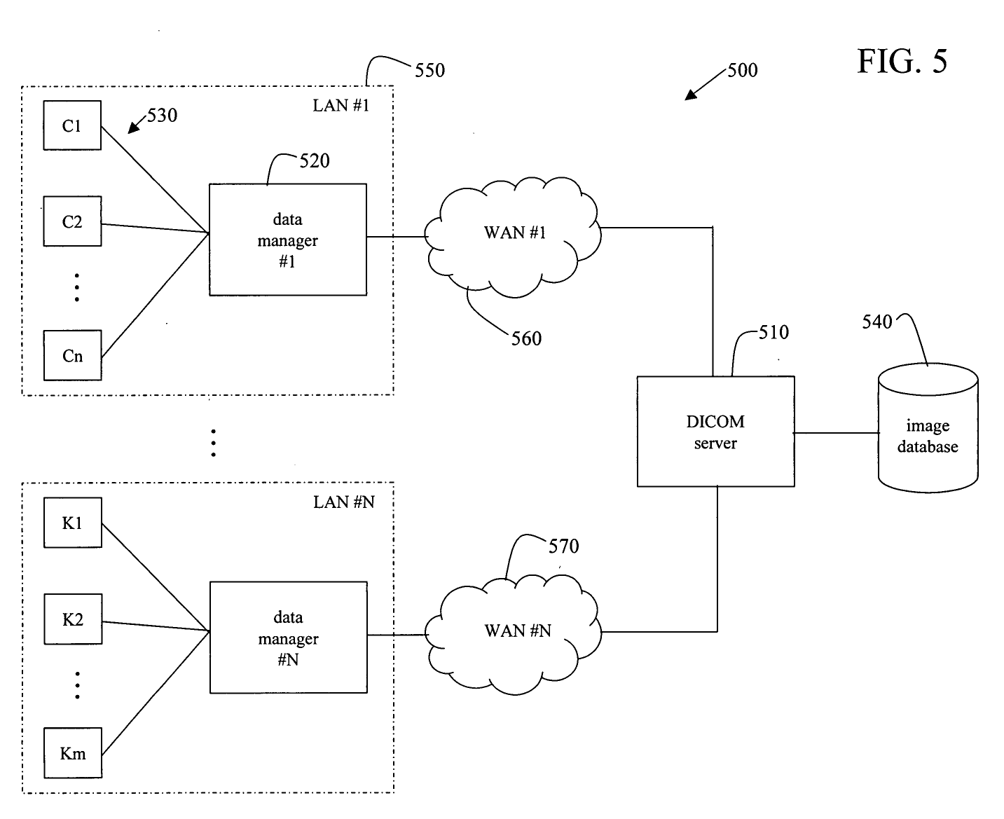

FIG. 5 is a schematic block diagram of an exemplary second embodiment of a system 500 to submit image requests to a DICOM server 510, in accordance with various aspects of the present invention. The system 500 comprises a first data manager 520 (data manager #1) operationally interfacing between a first plurality of computers 530 (C1 to Cn) and the DICOM server 510. The DICOM server 510 interfaces to a digital image database 540 in order to store digital medical images to and access digital medical images from the digital image data base 540. Alternatively, digital medical images may be stored on the DICOM server itself.

Each of the first plurality of computers 530 may include any processor-based platform such as, for example, a personal computer (PC), a work-station, or an imaging machine. The first data manager 520 operationally interfaces (wired or wirelessly) to the first plurality of computers 530 via a local area network (LAN) 550. The first data manager 520 operationally interfaces to the DICOM server 510 (wired or wirelessly) via a first wide area network (WAN) 560.

In accordance with various embodiments of the present invention, the system 500 may include additional data managers (e.g., data managers 2 to N) each operationally interfacing to a unique plurality of computers (e.g., K1 to Km). Each additional data manager operationally interfaces to the DICOM server 510 via an additional WAN (e.g., WAN 570 for data manager #N). Each data manager administers a security policy for authorizing the plurality of computers associated with each data manager. The DICOM server 510 administers a security policy only for authorizing the various data managers. As a result, the DICOM server 510 is not burdened with having to administer a security policy for all of the plurality of computers that may try to access images from or store images to the DICOM server 510.

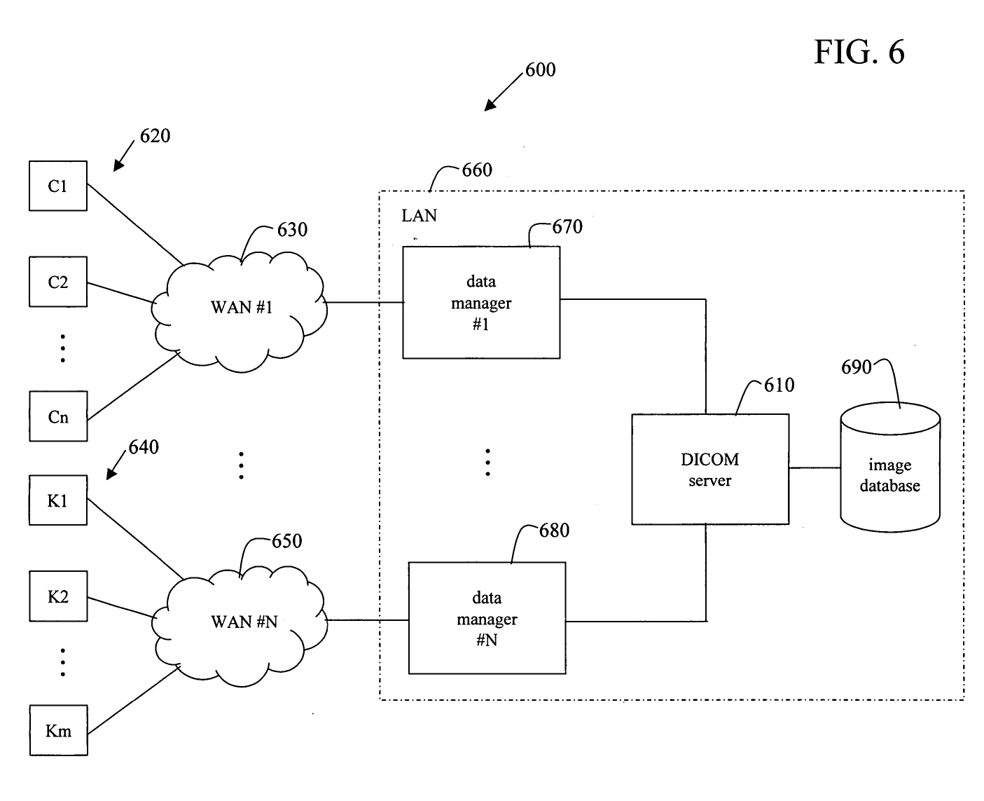

FIG. 6 is a schematic block diagram of an exemplary third embodiment of a system 600 to submit image requests to a DICOM server 610, in accordance with various aspects of the present invention. The system 600 includes a first plurality of computers 620 (C1 to Cn) operationally interfacing (either wired or wirelessly) to a first wide area network (WAN) 630. Each of the first plurality of computers 620 may include any processor-based platform such as, for example, a personal computer (PC), a work-station, or an imaging machine. The system 600 may also include additional pluralities of computers (e.g., 640, K1 to Km) each operationally interfacing (either wired or wirelessly) to an additional WAN (e.g., WAN 650). The system 600 further comprises a local area network (LAN) 660 operationally interfacing (either wired or wirelessly) to each of the WANs (WAN#1 630 to WAN #N 650). The LAN 660 includes a first data manager (data manager #1 670) through an Nth data manager (data manager #N 680), the DICOM server 610, and an image database 690.

As opposed to the embodiments of FIG. 1 and FIG. 5, in the embodiment of FIG. 6 the data managers are local to the DICOM server 610. Each data manager of the LAN 660 operationally interfaces (either wired or wirelessly) to a separate WAN, and each WAN operationally interfaces to a unique plurality of computers. As a result, the DICOM server 610 is isolated from the various pluralities of computers and, therefore, the security policy that is administered by the DICOM server 610 only has to handle the data managers (#1 to #N). Each data manager (e.g., 670) administers its own security policy for the corresponding plurality of computers (e.g., 620) that operationally interface to the data manager via a corresponding WAN (e.g., 630).

In accordance with an embodiment of the present invention, a security policy administered by a DICOM server can be implemented on the DICOM server according to the DICOM server format as shown in FIG. 4. In accordance with a first alternative embodiment of the present invention, a security policy administered by a DICOM server may involve the DICOM server accessing a separate data base to access and administer the security policy. In accordance with a second alternative embodiment of the present invention, a security policy administered by a DICOM server may involve the DICOM server using an existing LAN security policy (e.g., user_name/password security policy of the LAN).

In accordance with a third alternative embodiment of the present invention, a security policy administered by a DICOM server may involve the DICOM server relying on a security policy of a LAN which the DICOM is an operational part of. For example, if a data manager can access the LAN, which the DICOM server is an operational part of, then the DICOM server considers the data manager authorized (e.g., relying on active directory permission).

Other system configurations are possible as well, in accordance with various other embodiments of the present invention. A common feature of all embodiments of the present invention is that the security policy burden of a DICOM server is reduced by at least one data manager administering a security policy.

In summary, embodiments of the present invention provide a system and method to reduce the burden on a security policy administered by a DICOM server. Instead of the DICOM server having to consider (via a security policy) every requesting computer-based platform that may try to save an image to the DICOM server or retrieve an image from the DICOM server, at least one data manager is employed to act as a gateway between the DICOM server and the requesting computer-based platforms. The at least one data manager administers a security policy to consider the requesting computer-based platforms for authorization to submit image requests to the DICOM server. The DICOM server administers a security policy to consider only the data managers. As a result, the security policy of the DICOM server may only have to handle several data managers, whereas each data manager may handle, for example, hundreds of computer-based platforms.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

What is claimed is:

1. A system to submit image requests to a DICOM server, said system comprising a first data manager operationally interfacing between a first plurality of computer-based platforms and said DICOM server and administering a first security policy between said first plurality of computer-based platforms and said DICOM server, wherein each of said first plurality of computer-based platforms is capable of generating an image request, and wherein said DICOM server is capable of receiving and responding to said image request.

2. The system of claim 1 wherein said first data manager and said first plurality of computer-based platforms are part of a local area network (LAN) which operationally interfaces to said DICOM server via a wide area network (WAN) or via a global information network.

3. The system of claim 1 wherein said first data manager and said DICOM server are part of a local area network (LAN) which operationally interfaces to said first plurality of computer-based platforms via a wide area network (WAN) or via a global information network.

4. The system of claim 1 wherein said administering a first security policy comprises said first data manager determining if any requesting computer-based platform of said first plurality of computer-based platforms is authorized to access images from said DICOM server or submit images to said DICOM server.

5. The system of claim 4 wherein said first data manager sends an image request from a requesting computer-based platform of said first plurality of computer-based platforms to said DICOM server only if said first data manager has authorized said requesting computer-based platform of said first plurality of computer-based platforms via said first security policy.

6. The system of claim 5 wherein said DICOM server administers a second security policy to determine if at least said first data manager is authorized to access images from or submit images to said DICOM server.

7. The system of claim 6 wherein said DICOM server provides a digital image to said requesting computer-based platform of said first plurality of computer-based platforms via said first data manager only if said first data manager has authorized said requesting computer-based platform via said first security policy and said DICOM server has authorized said first data manager via said second security policy.

8. The system of claim 6 wherein said DICOM server saves a digital image received from said requesting computer-based platform of said first plurality of computer-based platforms, via said first data manager, only if said first data manager has authorized said requesting computer-based platform via said first security policy and said DICOM server has authorized said first data manager via said second security policy.

9. The system of claim 1 further comprising at least a second data manager operationally interfacing between a second plurality of computer-based platforms and said DICOM server and administering a second security policy between said second plurality of computer-based platforms and said DICOM server, wherein each of said second plurality of computer-based platforms is capable of generating an image request.

10. The system of claim 9 wherein said second data manager and said second plurality of computer-based platforms are part of a local area network (LAN) which operationally interfaces to said DICOM server via a wide area network (WAN) or via a global information network.

11. The system of claim 9 wherein said first data manager, said second data manager, and said DICOM server are part of a local area network (LAN) which operationally interfaces to said second plurality of computer-based platforms via a wide area network (WAN) or via a global information network.

12. The system of claim 9 wherein said administering a second security policy comprises said second data manager determining if any requesting computer-based platform of said second plurality of computer-based platforms is authorized to access images from said DICOM server or submit images to said DICOM server.

13. The system of claim 12 wherein said second data manager sends an image request from a requesting computer-based platform of said second plurality of computer-based platforms to said DICOM server only if said second data manager has authorized said requesting computer-based platform of said second plurality of computer-based platforms via said second security policy.

14. The system of claim 13 wherein said DICOM server administers a third security policy to determine if at least said first data manager and said second data manager are authorized to access images from or submit images to said DICOM server.

15. The system of claim 14 wherein said DICOM server provides a digital image to said requesting computer-based platform of said second plurality of computer-based platforms via said second data manager only if said second data manager has authorized said requesting computer-based platform of said second plurality of computer-based platforms via said second security policy and said DICOM server has authorized said second data manager via said third security policy.

16. The system of claim 14 wherein said DICOM server saves a digital image received from said requesting computer-based platform of said second plurality of computer-based platforms, via said second data manager, only if said second data manager has authorized said requesting computer-based platform via said second security policy and said DICOM server has authorized said second data manager via said third security policy.

17. A method to submit image requests to a DICOM server, said method comprising:
receiving a first image request at a first data manager from a first requesting computer-based platform;
administering a first security policy at said first data manager to determine if said first requesting computer-based platform is authorized to access images from or submit images to said DICOM server; and
sending said first image request from said first data manager to said DICOM server if said first data manager has determined, via said first security policy, that said first requesting computer-based platform is authorized to access images from said DICOM server or submit images to said DICOM server.

18. The method of claim 17 further comprising:
receiving said first image request at said DICOM server; and
administering a second security policy at said DICOM server to determine if said first data manager is authorized to access images from said DICOM server or submit images to said DICOM server.

19. The method of claim 18 further comprising sending a first image, corresponding to said first image request, from said DICOM server to said first data manager if said DICOM server has determined, via said second security policy, that said first data manager is authorized to access images from said DICOM server.

20. The method of claim 19 further comprising:
receiving said first image at said first data manager;
sending said first image from said first data manager to said first requesting computer-based platform; and
receiving said first image at said first requesting computer-based platform.

21. The method of claim 17 further comprising:
receiving a second image request at a second data manager from a second requesting computer-based platform;
administering a second security policy at said second data manager to determine if said second requesting computer-based platform is authorized to access images from or submit images to said DICOM server; and
sending said second image request from said second data manager to said DICOM server if said second data manager has determined, via said second security policy, that said second requesting computer-based platform is authorized to access images from said DICOM server or submit images to said DICOM server.

22. The method of claim 21 further comprising:
receiving said second image request at said DICOM server; and
administering a third security policy at said DICOM server to determine if said second data manager is authorized to access images from or submit images to said DICOM server.

23. The method of claim 22 further comprising said DICOM server saving a second image, corresponding to said second image request, if said DICOM server has determined, via said third security policy, that said second data manager is authorized to submit images to said DICOM server.

24. The method of claim 17 further comprising:
receiving a second image request at said first data manager from a second requesting computer-based platform;
administering said first security policy at said first data manager to determine if said second requesting computer-based platform is authorized to access images from or submit images to said DICOM server; and
sending said second image request from said first data manager to said DICOM server if said first data manager has determined, via said first security policy, that said second requesting computer-based platform is authorized to access images from or submit images to said DICOM server.

25. The method of claim 24 further comprising:
receiving said second image request at said DICOM server; and
administering a second security policy at said DICOM server to determine if said first data manager is authorized to access images from or submit images to said DICOM server.

26. The method of claim 25 further comprising sending a second image, corresponding to said second image request, from said DICOM server to said first data manager if said DICOM server has determined, via said second security policy, that said first data manager is authorized to access images from said DICOM server.

27. The method of claim 26 further comprising:
receiving said second image at said first data manager;
sending said second image from said first data manager to said second requesting computer-based platform; and
receiving said second image at said second requesting computer-based platform.
